(19) United States
(12) Patent Application Publication
(10) Pub. No.: US 2003/0231491 A1
(43) Pub. Date: Dec. 18, 2003

(54) Illumination apparatus having adjustable structure

(76) Inventor: Jen Hsieh Shih, Chang Hua (TW)

Correspondence Address: Jen Hsieh Shih, P.O. Box 63-298, Taichung, 406, TW

(21) Appl. No.: 10/173,388

(22) Filed: Jun. 18, 2002

(51) Int. Cl. F21L 4/04

(52) U.S. Cl. 362/199

(57) ABSTRACT

An illumination apparatus includes a coupler having a shaft rotatably secured in a base and having two flaps each of which includes an aperture and a number of depressions communicating with each other. A light device includes an extension received between the flaps, and a tube extended from the extension and having two ends rotatably received in the apertures of the flaps, and having one or more projections engaged in the depressions of the flaps, for securing the light device to the coupler at any angular positions. The coupler is rotatable relative to the base.

### BACKGROUND OF THE INVENTION

1. Field of the Invention

The present invention relates to an illumination apparatus, and more particularly to an illumination apparatus having an adjustable structure.

2. Description of the Prior Art

Various kinds of typical illumination apparatuses have been developed and comprise one or more light devices coupled to a base with a supporting bracket or coupler or the like.

U.S. Pat. No. 3,969,620 to Brooks, U.S. Pat. No. 4,091,442 to Markey, U.S. Pat. No. 4,214,294 to Bartlett, U.S. Pat. No. 4,892,278 to Huang, U.S. Pat. No. 5,050,054 to Hsu, U.S. Pat. No. 6,030,095 to Moore et al., U.S. Pat. No. 6,065,899 to Adams et al., U.S. Pat. No. 6,095,665 to Drake et al., and U.S. Pat. No. 6,371,631 to Reutemann disclose several of the typical illumination apparatuses.

However, the supporting bracket or coupler may only rotated relative to the base with a limited rotating angle, such that the light devices may not be freely rotated relative to the base with the supporting bracket or coupler.

U.S. Pat. No. 6,170,967 to Usher et al. discloses another illumination apparatus having one or more light devices pivotally or rotatably coupled to the supporting base or track with ball or universal joints.

However, the light devices also may not be freely rotated relative to the supporting base, and may only rotated relative to the supporting base in a limited angular or rotational range.

The present invention has arisen to mitigate and/or obviate the afore-described disadvantages of the conventional illumination apparatuses.

### SUMMARY OF THE INVENTION

The primary objective of the present invention is to provide an illumination apparatus including an adjustable structure for allowing the light devices to be freely rotated relative to the supporting base.

In accordance with one aspect of the invention, there is provided an illumination apparatus comprising a base including an orifice formed therein, and a coupler including a shaft extended therefrom and rotatably engaged in the orifice of the base, and including a pair of flaps extended therefrom, and a space formed therein or defined between the flaps. The flaps each includes an aperture formed therein, and a plurality of depressions formed therein and communicating with the aperture thereof. A light device includes an extension rotatably received in the space of the coupler, and a tube is laterally extended from the extension and has two ends rotatably received in the apertures of the flaps respectively. The tube includes at least one projection extended outward therefrom and selectively engaged in either of the depressions of the flaps, for securing the light device to the coupler at selected angular positions, and the coupler is rotatable relative to the base about the shaft, and the light device is rotatable relative to the coupler about the tube, for allowing the light device to be rotated freely relative to the base to any suitable or selected angular positions.

The tube includes a cut slot formed therein for defining at least one edge therein, and for increasing a resilience to force the projection to engage in either of the depressions of the flaps.

The projection is preferably located close to the edge for increasing the resilience to the edge and to force the at least one projection to engage in either of the depressions of the flaps.

The coupler preferably includes two half members secured together with fasteners, for allowing the ends of the tube to be easily engaged into the apertures of the flaps before the two half members are secured together with the fasteners.

The shaft includes at least one groove formed therein for forming at least one spring leg therein, the base includes at least one bulge extended inward the orifice thereof, for engaging into the groove of the shaft and for securing the shaft and the coupler to the base at selected angular positions.

The base is preferably a clip for clamping or clasping onto various objects, and for allowing the light device to be clamped or clasped onto various objects.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an exploded view of an illumination apparatus in accordance with the present invention;

FIG. 2 is a perspective view of the illumination apparatus;

FIG. 3 is a perspective view of a coupler;

FIG. 4 is a side view of the apparatus;

FIGS. 5, 6, 7 are enlarged partial side views illustrating the operation of the illumination apparatus;

FIG. 8 is a top schematic view illustrating the operation of the illumination apparatus;

FIG. 9 is a partial cross sectional view taken along lines 9-9 of FIG. 4;

FIG. 10 is a cross sectional view taken along lines 10-10 of FIG. 9; and

FIG. 11 is a cross sectional view similar to FIG. 10, illustrating the operation of the illumination apparatus.

### DETAILED DESCRIPTION OF THE PREFERRED EMBODIMENT

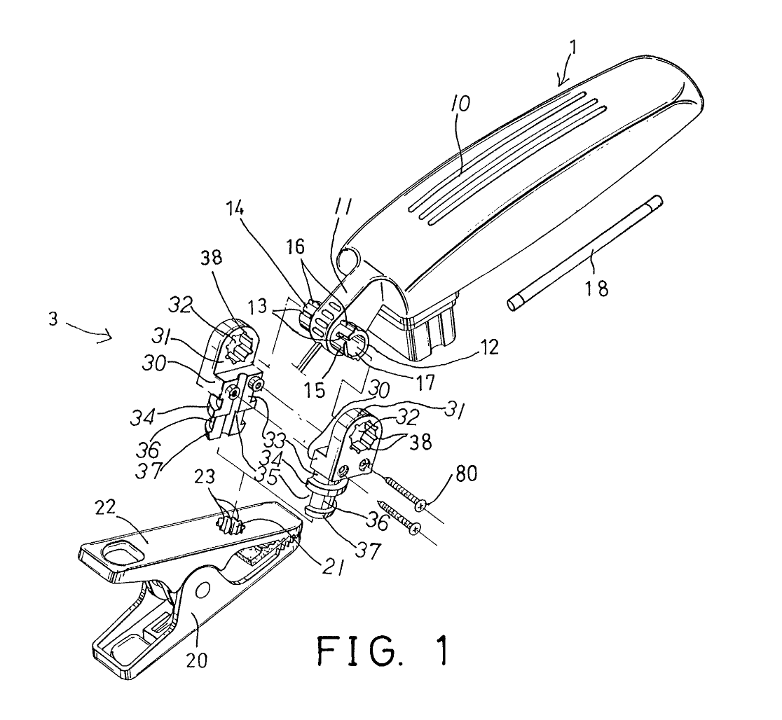

Referring to the drawings, and initially to FIGS. 1-4, an illumination apparatus in accordance with the present invention comprises a light device 1 to be pivotally or rotatably coupled to a supporting base 20, such as a clasp or a clamp or a clip 20 as shown in FIGS. 1, 2 and 4, with a coupler 3.

The clip 20 includes an orifice 21 formed in one of two arms or jaws 22 thereof, and one or more bulges 23 extended inwardly into the orifice 21 of the clip 20 or of the jaw 22.

The light device 1 includes a light housing 10 having an extension 11 extended therefrom, and having one or more light tubes or light bulbs or light members 18 attached thereto.

The light device 1 includes a tube 12 attached to or extended from the light housing 10, such as laterally extended from the extension 11 of the light housing 10, and having two ends extended outward or beyond the extension 11.

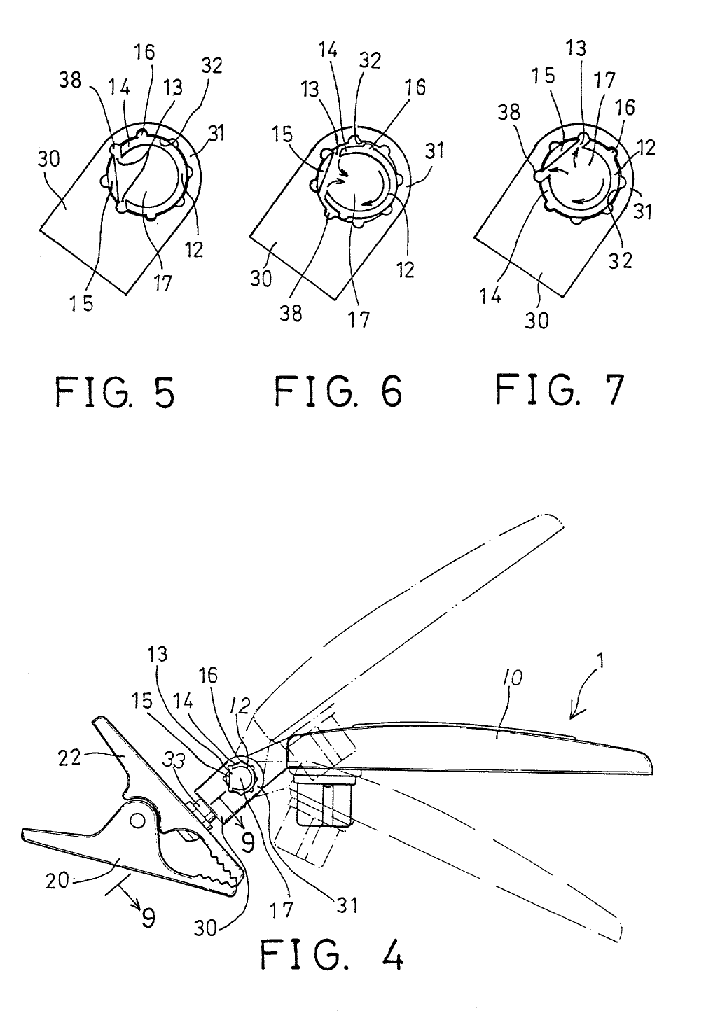

The ends of the tube 12 each includes a cut slot 13 formed therein for forming or defining a pair of spring edges 14 and a segment 15, best shown in FIGS. 4-7, and for allowing the edges 14 and/or the segment 15 to be depressed or forced inwardly into the bore 17 of the tube 12 (FIG. 6).

The ends of the tube 12 each further includes one or more projections 16 extended radially outward therefrom, preferably located close to the cut slot 13 or the edges 14 of the tube 12.

The coupler 3 may include two half members 30 secured together with one or more fasteners 80, and includes a pair of flaps 31 having a space 39 formed or defined between the flaps 31 for rotatably receiving the extension 11 of the light housing 10.

The flaps 31 each includes an aperture 32 formed therein for rotatably receiving the ends of the tube 12 respectively, and a number of depressions 38 formed therein and communicating with the aperture 32 thereof for selectively receiving the projections 16 of the tube 12.

In operation, as shown in FIGS. 4-7, when the tube 12 is forced to rotate relative to the coupler 3 by the light housing 10, the projections 16 of the tube 12 may be forced to be disengaged from the depressions 38 of the flaps 31, and the spring edges 14 may be forced inwardly into the bore 17 of the tube 12 (FIG. 6).

The projections 16 of the tube 12 may be forced or biased to engage into the other depressions 38 of the flaps 31 by the spring edges 14 when the projections 16 of the tube 12 are aligned with the depressions 38 of the flaps 31 again (FIG. 7).

Accordingly, as shown in FIG. 4, the light housing 10 of the light device 1 may be rotated relative to the coupler 3 to any suitable angular positions, as shown in solid lines and in dotted lines.

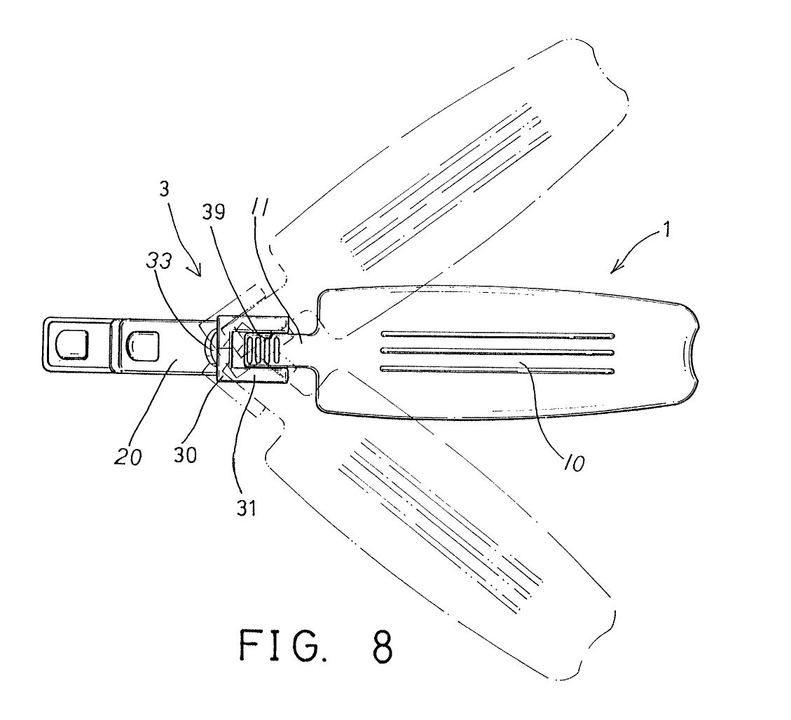

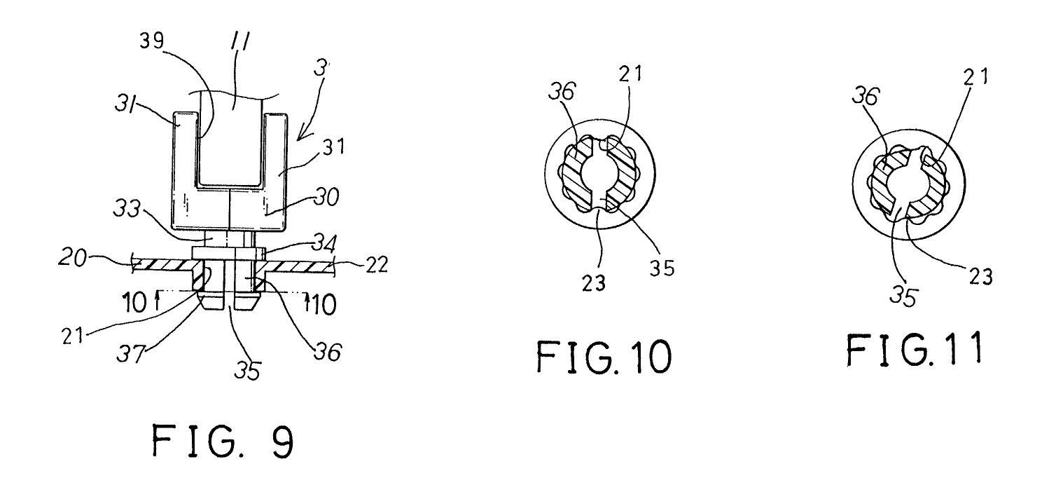

Referring next to FIGS. 8-11, and again to FIGS. 1-4, the coupler 3 includes a shaft 33 extended therefrom for rotatably engaging into the orifice 21 of the supporting base 20, and for allowing the shaft 33 and the coupler 3 to be rotated relative to the base 20 to any suitable angular position, best shown in FIG. 8.

The shaft 33 includes one or more peripheral flanges 34, 37 extended radially and outwardly therefrom for engaging with the base 20, and for rotatably securing the shaft 33 and the coupler 3 to the base 20.

The shaft 33 includes a slit or one or more grooves 35 formed therein for forming or defining one or more spring legs 36, and for engaging with the bulges 23 of the base 20, and for securing the coupler 3 to the base 20 at the required or selected angular position.

Also, or relatively, the bulges 23 of the base 20 may be engaged into the grooves 35 of the shaft 33 for securing the coupler 3 to the base 20 at the required or selected angular position.

In operation, as shown in FIG. 4, the light housing 10 or the light device 1 may be rotated relative to the coupler 3 freely by the rotational engagement of the tube 12 in the apertures 32 of the flaps 31 of the coupler 3.

As shown in FIG. 8, the coupler 3 and thus the light device 1 may be rotated relative to the base 20 freely by the rotational engagement of the shaft 33 in the orifice 21 of the base 20, such that the light device 1 may be rotated freely relative to the base 20.

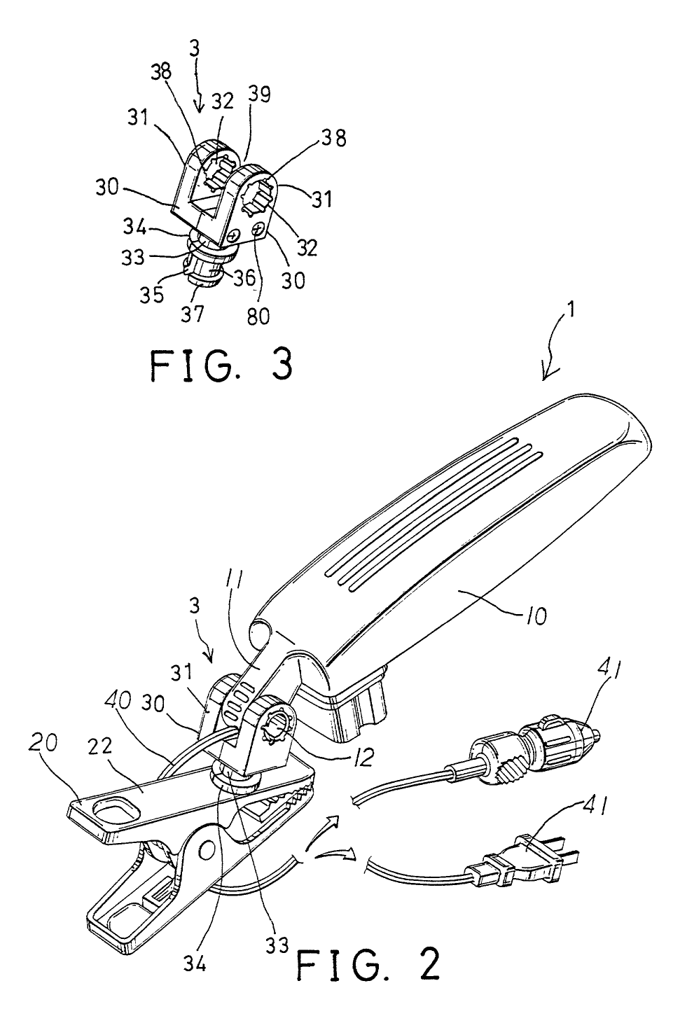

As shown in FIG. 2, one or more plugs or couplers 41 may be coupled to the light device 1 with cables or wires 40, for coupling the light device 1 to the electric power sources of the house buildings or of the vehicles, in order to energize the light device 1.

Accordingly, the illumination apparatus in accordance with the present invention includes an adjustable structure for allowing the light device to be freely rotated relative to the supporting base.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An illumination apparatus comprising:
a base including an orifice formed therein,
a coupler including a shaft extended therefrom and rotatably engaged in said orifice of said base, and including a pair of flaps extended therefrom, and a space formed therein or defined between said flaps,
said flaps each including an aperture formed therein, and a plurality of depressions formed therein and communicating with said aperture thereof,
a light device including an extension rotatably received in said space of said coupler, and a tube laterally extended from said extension and having two ends rotatably received in said apertures of said flaps respectively, and
said tube including at least one projection extended outward therefrom and selectively engaged in either of said depressions of said flaps, for securing said light device to said coupler at selected angular positions, and
said coupler being rotatable relative to said base about said shaft, and said light device being rotatable relative to said coupler about said tube, for allowing said light device to be rotated freely relative to said base.

2. The illumination apparatus according to claim 1, wherein said tube includes a cut slot formed therein for defining at least one edge therein, and for increasing a resilience to force said at least one projection to engage in either of said depressions of said flaps.

3. The illumination apparatus according to claim 2, wherein said at least one projection is located close to said at least one edge for increasing the resilience to said at least one edge and to force said at least one projection to engage in either of said depressions of said flaps.

4. The illumination apparatus according to claim 1, wherein said coupler includes two half members secured together with fasteners.

5. The illumination apparatus according to claim 1, wherein said shaft includes at least one groove formed therein for forming at least one spring leg therein, said base includes at least one bulge extended inward said orifice thereof, for engaging into said at least one groove of said shaft and for securing said shaft and said coupler to said base at selected angular positions.

6. The illumination apparatus according to claim 1, wherein said base is a clip.
